(19) United States
(12) Patent Application Publication
(10) Pub. No.: US 2005/0173977 A1
(43) Pub. Date: Aug. 11, 2005

(54) Vehicle brake system comprising a service brake system and a parking brake system

(76) Inventor: Joerg Fischer, Esslingen (DE)

Correspondence Address: FASSE PATENT ATTORNEYS, P.A., P.O. BOX 726, HAMPDEN, ME, 04444-0726, US

(21) Appl. No.: 10/514,768

(22) PCT Filed: Mar. 18, 2003
(86) PCT No.: PCT/EP03/02782

(30) Foreign Application Priority Data
May 16, 2002 (DE) 102 21 740.8

(51) Int. Cl. B60T 17/16

(52) U.S. Cl. 303/89; 188/265; 188/106 P

(57) ABSTRACT

The invention relates to a vehicle brake system having a service brake system and a parking brake system. A vehicle brake system is formed from a service brake system and a parking brake system. The service brake system can be activated by the driver by means of an operator control element, a service brake pedal. When the service brake is activated, application elements of the service brake are applied so that a braking effect is generated. Furthermore, an evaluation unit is provided. The evaluation unit is supplied with information about the activation of the service brake and with at least one further item of information. Under appropriate conditions, the parking brake system is activated by the evaluation unit in order to immobilize the vehicle by means of the parking brake. For this purpose, application elements of the service brake system are held in their applied position by a locking element until they are released, without further activation of an activation means and without further supply of energy. Furthermore, an activation means which is independent of the evaluation unit is provided for activating the parking brake system.

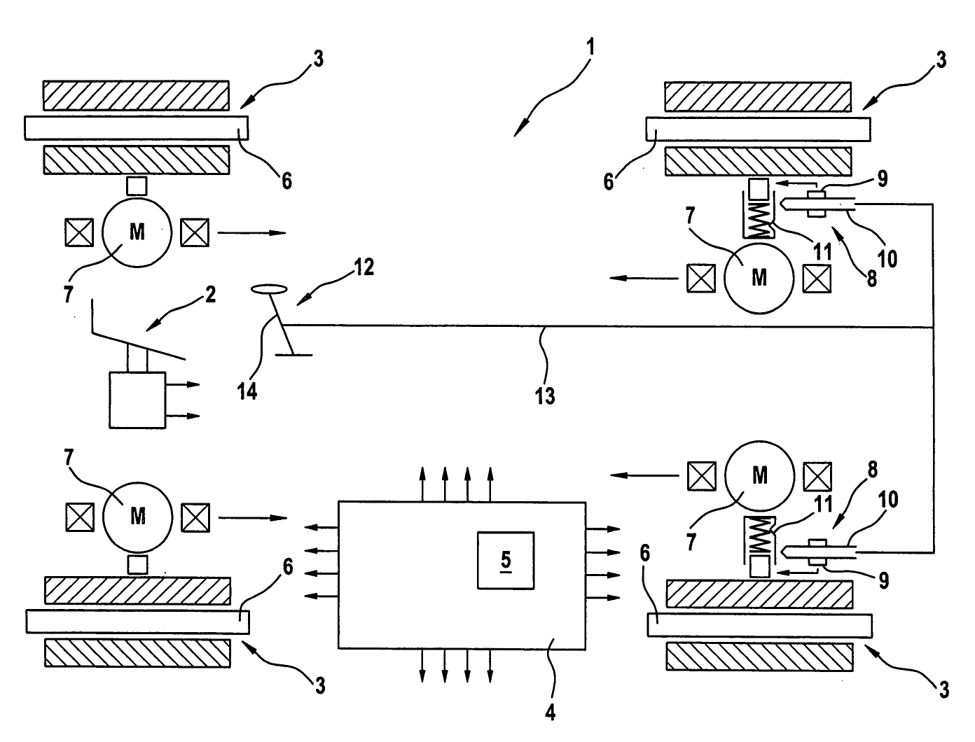

The invention relates to a vehicle brake system having a service brake system and a parking brake system.

Vehicles which have a service brake system and a parking brake system are generally known. The vehicles usually have a brake pedal for activating the service brake. In order to activate the parking brake system, a parking brake activation means which is different from the brake pedal is usually provided, said means being suitable for activating a parking brake, this is to say for moving its application means into a braking position in which a braking intervention occurs, and releasing them again. In this context, the parking brake is embodied in such a way that its application means remain in their braking position without further activation or supply of energy. This is carried out in particular by means of mechanical locking, for example by means of detent pawls.

Furthermore, it is known from DE 199 08 062 A1, which forms the generic type, that application elements of the service brake can simultaneously be used as application elements of the parking brake system, the parking brake being embodied in such a way that after the parking brake has been activated, the application elements of the service brake remain in their applied, braking position, even if no further activation or supply of energy occurs. In this context, either the service brake or the parking brake can be actuated by the operator control element as a function of a further signal, specifically the velocity of the vehicle, when an operator control element is activated. If the velocity of the vehicle is above a limiting value, the service brake is triggered by means of the operator control element, whereas below the limiting value for the velocity of the vehicle the parking brake is triggered.

Service brakes which have a parking brake function when a further item of information, for example a value of the velocity of the vehicle, is available are advantageous for example, because they can be used to prevent a vehicle being parked without an activated parking brake so that it is not sufficiently secured against unintentional rolling away.

A disadvantage of such parking brakes is the dependence on an evaluation in which it is evaluated whether or not the parking brake is to be activated at a specific time. This evaluation requires a functioning evaluation circuit.

The object of the present invention is to embody such a vehicle brake system in such a way that the parking brake system can be activated even if the evaluation unit which actuates its function fails.

The object of the invention is achieved by means of a vehicle brake system as claimed in claim 1.

A vehicle brake system according to the invention is formed from a service brake system and a parking brake system. The service brake system can be activated by the driver by means of an operator control element, a service brake pedal. When the service brake is activated, application elements of the service brake are applied so that a braking effect is generated. Furthermore, an evaluation unit is provided. The evaluation unit is supplied with information about the activation of the service brake and with at least one further item of information. Under appropriate conditions, the parking brake system is activated by the evaluation unit in order to immobilize the vehicle by means of the parking brake. For this purpose, application elements of the service brake system are held in their applied position by a locking element until they are released, without further activation of an activation means and without further supply of energy. Furthermore, an activation means which is independent of the evaluation unit is provided for activating the parking brake system.

According to one advantageous embodiment, the further activation means is an emergency operator control element which is not activated in the normal operating mode of the vehicle. Such an emergency operator control element may be embodied in such a way that when it is activated the application elements of the service brake system, which are also used for the parking system, are applied. Alternatively, it is also possible that the application elements are firstly applied by means of the service brake system by correspondingly activating the service brake pedal, and the emergency operator control element, which acts on locking elements which keep the corresponding application elements in the applied position, are not activated until after this.

According to embodiments of the invention, the further activation means comprise both mechanical and fluid transmission means which the activation of the operator control element passes on to the corresponding actuators of the parking brake system.

One embodiment of the invention is illustrated in the drawing. The single FIGURE is a schematic illustration of a vehicle brake system according to the invention.

The FIGURE is a schematic illustration of a vehicle brake system 1. The vehicle brake system 1 has a service brake pedal 2 as activation means of the service brake system. In the exemplary embodiment illustrated, the brake pedal 2 is not used directly to generate the activation force of the application elements 3 which are assigned to the individual wheels of the vehicle, with one application element 3 being provided on each wheel. Instead the service brake pedal 2 serves as a set point value transmitter which can be activated via the driver. By activating the service brake pedal 2, the driver generates a signal which is evaluated in the control device 4 which also includes the evaluation unit 5.

The control device 4 generates a brake signal on the basis of the signal which represents the braking request, possibly taking into account further operating and state variables of the vehicle, and said brake signal is fed to the brake controllers 7. Each application element 3 is assigned one brake controller 7. The brake controller 7 generates an application movement of the assigned application element 3 on the basis of the brake signal which is supplied to the brake controller 7, for example an electric motor. In this case, the application elements are brake linings which are arranged in a brake saddle which is secured to the vehicle and which thus move into a position of abutment against the brake disk 6 which is moved along with the corresponding wheel. The braking effect is produced as a result of frictional locking between the brake linings and the brake disk 6. Although this has been described with reference to a disk brake system, the invention can correspondingly also be implemented with drum brakes.

The parking brake system is formed from the service brake pedal 2, the evaluation unit 5 of the control device 4 and from some of the application elements 3, in the illustrated example embodiment the application elements 3 of the service brakes of the rear axle of the vehicle, and the locking elements 8 arranged there. The locking elements 8 act at least indirectly on the application elements 3. They are, for example, activated electromagnetically. The parking brake is activated by means of the evaluation unit 5 of the control device 4. If it is determined there that a case of parking braking is occurring, the locking elements 8 are actuated. The locking elements 8 lock the corresponding application elements 3 of the service brake system in a position in which the braking effect on the application elements involved is so large that the vehicle remains in a stationary state even on inclines.

The locking elements 8 are, for example, detent pawls 10 which can be displaced between two stable end positions by means of an electromagnet 9. In the illustrated position of rest, the parking brake system is opened. When the parking brake function is activated, the detent pawl 10 is pushed by the effect of the electromagnet 9 into a position which forms the other end position and in which it engages in a catch 11 which is formed at the application element end. The detent pawl 10 then holds the application elements 3 in their closed position in a mechanically locked fashion. There is no need for a continuing activation of an activation means or for a continuing supply of energy. For this purpose, the other end position can also be maintained by self-locking between the detent pawl 10 and catch 11.

The evaluation unit 5 is supplied with the signal which is generated by the brake pedal 2. For the parking brake to be activated, the brake pedal must be carrying out braking, if appropriate also braking with a predefined minimum activation displacement of the brake pedal 2. Furthermore the evaluation unit 5 is supplied with at least one further item of information. If, in addition to the brake pedal, this at least one further item of information lies within a predefined value range, the evaluation unit 5 determines that the parking brake is to be activated.

Examples of the at least one further item of information are the velocity of the vehicle, the position of the ignition switch and/or, however, also the activation of an electrical switching element which can be activated by the driver. For example, the parking brake can be activated whenever the service brake is activated and the vehicle is in a stationary state. The vehicle is then protected against unintentional rolling off even if the driver ends the activation of the brake pedal. The parking brake can be activated even when the ignition key is withdrawn, preferably if the key leaves the “ignition on” position and is moved in the direction of “ignition off”. It is alternatively or additionally also possible to provide an electrical switching element which activates the parking brake if a corresponding signal is transmitted to the evaluation unit by the driver owing to the activation.

The release of the parking brake is also controlled by the control device. Therefore, the release can take place, for example, if a predefined drive torque in the drive train is exceeded.

According to the invention, in addition to the evaluation unit 5 of the control device 4 there is also a further activation device for the brake pedal. This device is the emergency operator control element 12. The emergency operator control element 12 has here a Bowden cable 13 which can be loaded in a pulling or pushing fashion and which is used for transmitting force. An operator control lever 14 which can be activated by the driver is used as the activation means. The Bowden cable acts on the detent pawl 10 and can also move it between its two end positions without the effect of the electromagnet 9, or even counter to its effect.

In order to activate the parking brake using the operator control lever 14, which is part of the emergency operator control element 12 and is therefore not used in the normal driving mode, it is firstly necessary to activate the service brake pedal in such a way that the application elements 3 are applied. The operator control lever is then moved into the closed position. As a result, a force is transmitted to the detent pawl 10 via the Bowden cable 13 and said detent pawl 10 is moved from its illustrated opened end position into the other end position which prevents the application elements 3 of the rear axle from opening. The detent pawl 10 then engages in the catch 11 and the parking brake is applied and mechanically locked. A stable end position of the detent pawl 11 is brought about. The activation of the service brake pedal 2 can be ended.

In order to release the mechanical lock by means of the Bowden cable, the operator control lever 14 must be moved into its original starting position again.

The parking brake can therefore be activated by the emergency operator control element independently of the control device 4 and of the evaluation logic. This is possible in particular even if faults are present in the vehicle's electrical system or the control electronics. This constitutes a purely mechanical fall-back solution which, however, requires only a small number of additional components in comparison with the purely electronically controlled parking brake which is integrated into the service brake.

Since the operator control lever 14 of the emergency operator control element 12 cannot be activated on a normal basis but only exceptionally, the operator control lever can be arranged at less easily accessible positions in the field of operation of the driver. The operating comfort can also be reduced, for example the activation forces which are necessary for activation can be made larger in comparison with a parking brake which always has to be activated mechanically. It is to be noted here that in the illustrated embodiment it is not necessary to apply the activation force of the parking brake to the operator control lever 14 but rather merely an engagement force or disengagement force for the detent pawl 10 has to be applied.

As an alternative to a Bowden cable it is, for example, also possible to carry out emergency operator control of the parking brake by means of a locking screw or a locking wheel which, if appropriate, also acts directly on the application elements. Likewise, instead of the Bowden cable it is also possible to activate the detent pawl fluidically, in particular pneumatically. In this case, there should preferably be provision for spring cylinders to be prestressed and for the detent pawl to be held in the opened end position by fed-in pressure. The operator control element then vents the spring cylinder and moves the detent pawl 11 into the other end position, this is to say in engagement with the latch 11, by means of the spring effect.

1. A vehicle brake system having a service brake system and a parking brake system, wherein the service brake system can be activated by the driver by means of a service brake pedal, as a result of which application elements which generate the braking effect are applied, wherein an evaluation unit is provided in which the parking brake system is actuated on the basis of the activation of the service brake pedal and of at least one further item of information, as a result of which application elements of the service brake system are held in their applied position by a locking element until it is released, without further activation of an activation means and without further supply of energy, characterized in that a further activation means which is independent of the evaluation unit is also provided for activating the parking brake system.

2. The vehicle brake system as claimed in claim 1, characterized in that wherein the further activation means is an emergency operator control element which is not activated in the normal operating mode of the vehicle.

3. The vehicle brake system as claimed in claim 2, characterized in that the emergency operator control element can apply the application elements of the service brake system which are used by the parking brake system.

4. The vehicle brake system as claimed in claim 2, characterized in that the emergency operator control element acts on locking elements which keep the application elements of the service brake system in the applied position without further activation of an activation means, wherein the applied position of the application elements is brought about by activating the service brake pedal.

5-8. (canceled)

9. The vehicle brake system as claimed in claim 1, characterized in that the further activation means is a mechanical activation means which locks the parking brake in a releasable fashion.

10. The vehicle brake system as claimed in claim 9, characterized in that the further activation means is a Bowden cable, in particular a Bowden cable which can be used in pushing and pulling mode.

11. The vehicle brake system as claimed in claim 9, characterized in that the further activation means is a mechanical activation element, for example a locking and release screw, which acts on the locking element.

12. The vehicle brake system as claimed in claim 1, characterized in that the further activation means is an activation means which pneumatically locks the parking brake in a releasable fashion, said means being, for example, a pneumatic valve unit which activates the lock.
